(19) United States
(12) Patent Application Publication
(10) Pub. No.: US 2024/0241584 A1
(43) Pub. Date: Jul. 18, 2024

(54) System and Method for Haptic Stimulation Creation based on Existing Media

(71) Applicants: Kfir BARLEVAV, Elad (IL); Mor Efrati, Tel Aviv (IL); Uri Kareev, Tel Aviv (IL)

(72) Inventors: Kfir BARLEVAV, Elad (IL); Mor Efrati, Tel Aviv (IL); Uri Kareev, Tel Aviv (IL)

(21) Appl. No.: 18/411,659

(22) Filed: Jan. 12, 2024

Related U.S. Application Data
(60) Provisional application No. 63/438,566, filed on Jan. 12, 2023.

(51) Int. Cl. G06F 3/01; G06F 3/16

(52) U.S. Cl. CPC G06F 3/016; G06F 3/165

(57) ABSTRACT

A system for generating haptic effects having a processor having a memory configured to receive one or more of one or more audio signals and one or more video signals; and one or more haptic transducers. The processor is configured to analyze one or more of an audio stream and a input video stream to detect one or more predetermined events in the stream. For each detected event, the processor generates a first haptic signal of one or more predetermined haptic effects associated with the detected event, and sends the first haptic signal to one or more haptic transducers. The processor may also be configured to generate a second haptic signal based upon an analysis of one or more of the input signals and to send the second haptic signal to the one or more transducer simultaneously with the first haptic signal.

### FIELD OF THE INVENTION

This invention relates to generating haptic stimulation.

### BACKGROUND OF THE INVENTION

In various forms of media, audio and video content are generated, edited or manipulated in various ways to optimize them for listening and viewing, but lack the capability of generating for tactile sensation. Such media include video clips, audio tracks, video games and so on. In cases where it is desired to generate haptic stimulation to complement the audio or video content it is usually derived in one of three methods: a) dedicated creation of the haptic track, b) converting the audio track to haptic stimulation, and c) reshaping the audio file by optimizing specific frequencies that have a strong or more adequate haptic effect. US published patent publication 20110190058 to Houston, describes such a system.

The existing solutions, even those manipulating the content, do it in a uniform manner such as applying filters to the entire stream which often produces a poor representation of the actual real-world haptic sensation.

### SUMMARY OF THE INVENTION

The present invention provides a system and method for generating haptic effects. The system of the invention comprises a processor configured to receive as an input one or more of one or more an audio signals and one or more video signals. The system also comprises one or more haptic transducers. The processor is configured to analyze one or more of the input signals, to generate one or more first haptic signals. The processor has a memory in which one or more predetermined events are stored together with one or more haptic effects associated with one or more of the events. The processor is configured to analyze one or more of the input signals to detect one or more of the stored events in the input signals, and for each of one or more detected events, to generate one or more haptic signals indicative of one or more of the haptic effects associated with the detected event and to send the generated haptic signal to one or more of the haptic transcoders. The haptic transduces are typically incorporated into a garment, such as a vest or wrist band, but may also be embedded into a piece of furniture, such as a chair.

The system of the invention may further comprise any one or more of:
(a) one or more display surfaces; and
(b) one or more speakers.

For each detected event, the processor generates a trigger or impulse at onset of each event. The processor then recalls from the memory, one or more haptic effects previously associated with each event. An audio or video channel may also be analyzed and generate one or more second haptic signals that are sent to one or more of the transducers simultaneously with the one or more first haptic signals. As an example, the second haptic signal may be sent to one or more of the haptic transducers between the occurrence of a detected event, while being silent during the events. As another example, the second haptic signal may have a higher intensity between events and lower intensity during events.

Thus, in one of its aspects, the present invention provides a system for generating haptic effects comprising:
(a) a processor having a memory configured to receive one or more of one or more audio signals and one or more video signals; and
(b) one or more haptic transducers;
wherein the processor is configured to execute a process comprising:
   analyzing one or more of an audio stream and a input video stream to detect one or more predetermined events;
   for each detected event generating a trigger at the onset of the event;
   generating a first haptic signal of one or more predetermined haptic effects, where each haptic effect begins at a location of a trigger;
   sending the first haptic signal to one or more transducers.

The process may further comprise:
generating a second haptic signal based upon an analysis of one or more of the input audio signal and the input video signal; and
sending the second haptic signal to one or more transducer simultaneously with the first haptic signal.

In the system of the invention, the second haptic signal may be active between one or more of the detected events and silent during one or more of the detected events. The second haptic signal may have a first intensity between one or more of the detected events and a second intensity during one or more of the detected events, where the second intensity is less than the first intensity. The second haptic signal may have a first intensity between one or more of the detected events and a second intensity during one or more of the detected events, where the second intensity is greater than the first intensity.

In the system of the invention, one or more of the audio stream and the video stream may be selected from:
a meta-data file;
a file pre-stored in the memory;
a multi-channel file;
a streaming file;
a file generated in real time;

The processor may be further configured to execute a step of preprocessing of one or more of the audio stream and the video stream prior to the step of identification of events. The preprocessing may comprise, for example, any one or more of reshaping of one or more of the audio stream and the video stream and replacing segments of one or both of the audio stream and the video stream in one or more frequency bands.

The analysis of one or more of the audio stream and the video stream may comprise combining the audio stream with the video stream in a process involving a correlation between the audio stream and the video stream.

The processor may be further configured to execute a step of relocating one or more predetermined components of one or more of the audio signal and the video signal in the stream.

Identification of one or more events comprises any one or more of:
a. a spatial location of a source of one or more of the audio steam and th video stream;
b. a spatial location of a user;
c. a movement or gesture of a user or a body part of a user;.

The event identification may involve any one or more methods selected from:
d. waveform identification;
e. signal envelope analysis;
f. time domain correlation;
g. frequency domain segmentation and correlation;
h. surrounding events analysis;
i. embedded triggers;
j. object identification;
k. object contour identification;
l. image domain correlation;
m. image frequency domain segmentation and correlation; and
n. surrounding object analysis.

The analysis of one or more of the audio stream and the video stream may comprise combining the audio stream with the video stream in a process involving a correlation between the audio stream and the video stream.

In another of its aspects, the invention provides a method for generating haptic effects comprising:
analyzing one or more of an audio stream and a video stream to detect one or more predetermined events;
for each detected event generating a trigger at the onset of the event;
generating a first haptic signal of one or more predetermined haptic effects, where each haptic effect begins at a location of a trigger; and
sending the first haptic signal to one or more transducers.

The method may further comprises:
generating a second haptic signal based upon an analysis of one or more of the input audio signal and the input video signal; and
sending the second haptic signal to one or more transducer simultaneously with the first haptic signal.

The second haptic signal may be active between one or more of the detected events and is silent during one or more of the detected events. The second haptic signal may have a first intensity between one or more of the detected events and a second intensity during one or more of the detected events, where the second intensity is less than the first intensity. The second haptic signal may have a first intensity between one or more of the detected events and a second intensity during one or more of the detected events, where the second intensity is greater than the first intensity.

### BRIEF DESCRIPTION OF THE DRAWINGS

FIG. 1 shows a diagram of a haptic enhancement system in accordance with one embodiment of the invention;

FIG. 2 shows a haptic enhancement system in accordance with another embodiment of the invention;

FIG. 3 shows different combinations of a first haptic signal and a second haptic signal; and

FIG. 4 shows a flowchart of a method for generating haptic effects in accordance with one embodiment of the invention.

### DETAILED DESCRIPTION OF THE INVENTION

FIG. 1 shows schematically a diagram of a haptic generating system 2, in accordance with one embodiment of the invention. A processor 30 is configured to receive as an input audio track 20, and an input a video track 10. The processor 30 is configured to analyze one or more of the input audio track and the input video track 10 to generate a haptic stimulus signal 40. The processor 30 has a memory in which one or more predetermined events are stored together with one or more haptic effects associated with one or more of the events. The audio track 20 is also input to a one or more speakers 21 that may be incorporated into a set of earphones. The video track 10 is input into one or more display devices 11, such as a screen or a pair of goggles. The haptic track 40 is input to one or more haptic transducing devices 41. The haptic transducing devices 41 are typically included in a garment, such as a vest, to be worn by a user that allows the user to sense haptic stimulation generated by the haptic transducers 41.

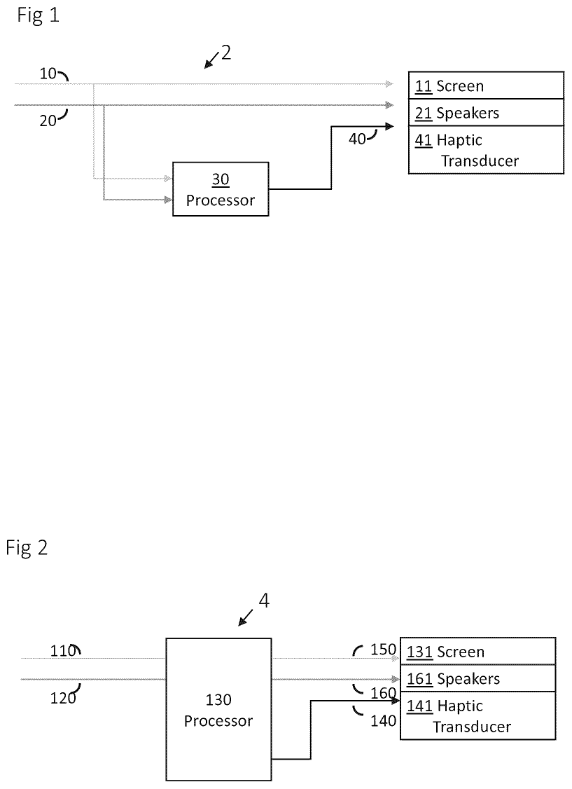

FIG. 2 shows schematically a haptic generating system 4 in accordance with another embodiment of the invention. The system 4 includes a processor 130 configured to receive an input audio track 120 and an input video track 110. The processor 130 has a memory in which one or more predetermined events are stored together with one or more haptic effects associated with one or more of the events. The processor 130 analyzes one or more of the input audio track 120, and the input video track 110 and, on the basis of this analysis, generates an output video track 150, an output audio track 160 and an output haptic track 140. The output audio track 160 is input to a one or more speakers 161 that may be incorporated into a set of earphones. The output video track 150 is input into one or more display devices 151, such as a screen or a pair of goggles. The output haptic track 140 is input to one or more haptic transducing devices 141. The haptic transducing devices 141 are typically included in a garment, such as a vest, to be worn by a user that allows the user to sense haptic stimulation generated by the haptic transducers 141.

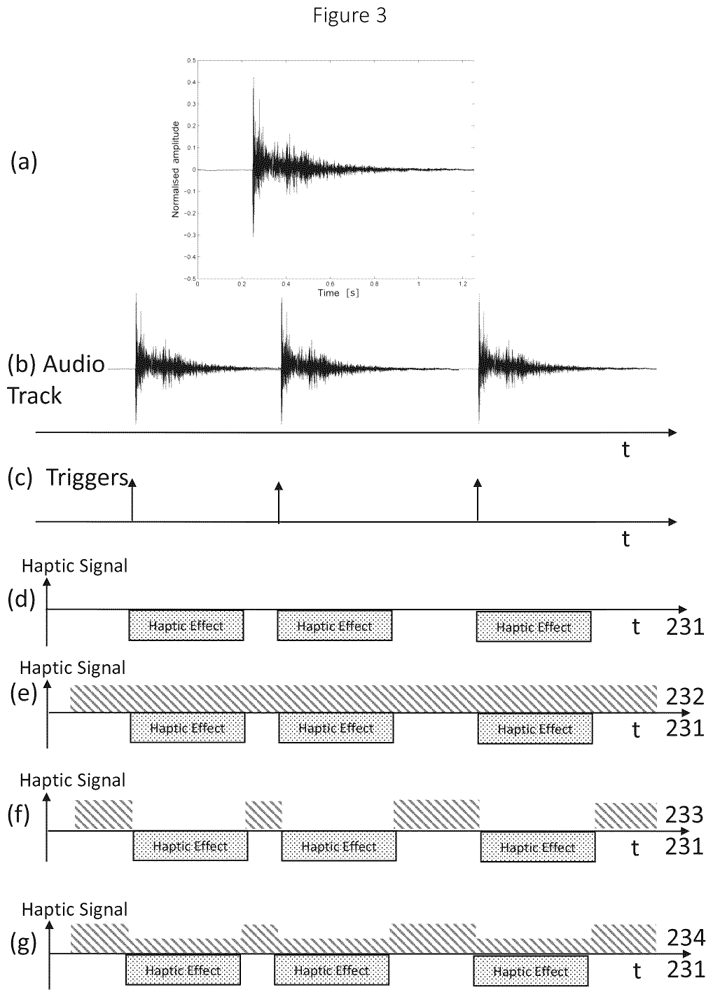

As, an example, FIG. 3a shows a characteristic wave form of a gunshot identified by the system in an audio channel, that might simultaneously also contain other audio components such as music, or simulations of other environmental effects. The processor, in an analysis of an audio channel might detect a sequence of three consecutive gunshots, as shown in FIG. 3b. As shown in FIG. 3c, the processor then generates a sequence of three haptic event triggers, or impulses, each of the triggers indicating the onset of one of the gunshots. The processor then recalls from the memory, one or more haptic effects previously associated with a gunshot. In FIG. 3d, a first haptic signal 231 is generated comprising three pulses and sent to one or more of the haptic transducers that creates a sequence of three haptic effects corresponding to a gunshot where a haptic effect is created simultaneously with each of the gunshots identified in the audio channel. As another example, shown FIG. 3e, the audio channel is analyzed and used to create a second haptic signal 232 that is sent to one or more of the transducers simultaneously with the first haptic signal 231. As yet another example, shown in FIG. 3f, the audio channel is analyzed and used to create a third haptic signal 233 that is sent to one or more of the haptic transducers between the gunshot haptic effects in the haptic signal 231. As still another example shown in FIG. 3g, the audio signal is analyzed to generate a fourth haptic signal 234 that is sent to one or more of the haptic transducers simultaneously with the haptic signal 231 of the of the gunshots, but is of reduced intensity, while not being completely silenced, during the periods of the gunshots.

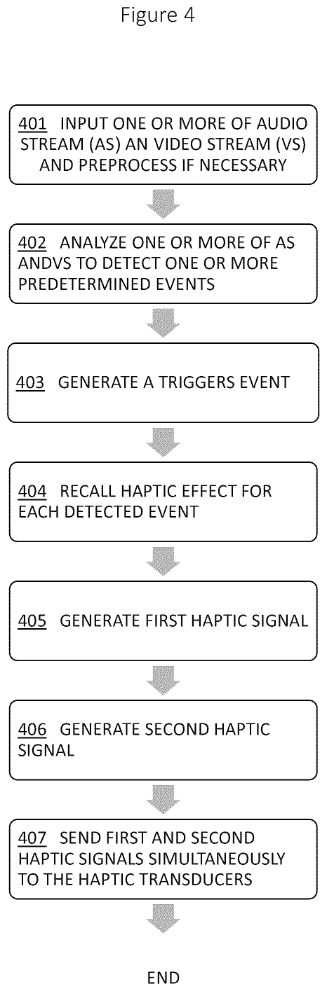

FIG. 4 shows a flowchart of a method carried out by the processor of the system in accordance with one embodiment of the invention. In step 401, one or more of an audio steam and a video stream is input to the processor. One or more of the audio stream (AS) and the video stream may be a pre-existing stream or may be generated on the fly.

The audio stream (AS) may be prepossessed in step 401. For example, the pre-processing may include, any one or more of the following: band pass/block filtering, level optimization, identification and attenuation of non-relevant elements such as narrator voice or background music. The application of filtering may be experience dependent. For example, in some cases, the background music may be attenuated while in others it may be analyzed and used as part of the haptic stimulation.

The video stream may be prepossessed in step 401. For example, the pre-processing may include, any one or more of the following: frame rate reduction, level optimization, and resolution manipulation. The application of filtering may be experience dependent. For example, in some case objects in the background may be ignored while in others the background are analyzed. Additionally or alternatively, objects in the background may be used as triggers for haptic stimulation.

In step 402, one or more of the input audio stream and the input video stream is analyzed to detect one or more predetermined events, such as the gunshot in the examples of FIG. 3. In step 403, for each event detected in step 402, a trigger is generated at the onset of the event. In step 404, for each event identified in step 402, a predetermined haptic effect corresponding to the identified event is recalled from the memory of the processor.

In step 405, a first haptic signal is generated consisting of a sequence of one or more haptic events, where each haptic event begins at the location of one of the triggers generated in the step 403. In step 406, a second haptic signal is generated based upon an analysis of one or more of the input audio signal and the input video signal. In step 407 the first haptic signal and the second haptic signal are sent to one or more haptic transducers, where the first haptic signal and the second haptic signal are transmitted simultaneously to the haptic transducers. The process may be repeated as many times as is necessary in any application.

1. A system for generating haptic effects comprising:
(a) a processor having a memory configured to receive one or more of one or more audio signals and one or more video signals; and
(b) one or more haptic transducers;
wherein the processor is configured to execute a process comprising:
analyzing one or more of an audio stream and a input video stream to detect one or more predetermined events;
for each detected event generating a trigger at the onset of the event;
generating a first haptic signal of one or more predetermined haptic effects, where each haptic effect begins at a location of a trigger;
sending the first haptic signal to one or more transducers.

2. The system according to claim 1 wherein the process further comprises:
generating a second haptic signal based upon an analysis of one or more of the input audio signal and the input video signal; and
sending the second haptic signal to one or more transducer simultaneously with the first haptic signal.

3. The system according to claim 2 wherein the second haptic signal is active between one or more of the detected events and is silent during one or more of the detected events.

4. The system according to claim 2wherein the second haptic signal has a first intensity between one or more of the detected events and a second intensity during one or more of the detected events, where the second intensity is less than the first intensity.

5. The system according to claim 2 wherein the second haptic signal has a first intensity between one or more of the detected events and a second intensity during one or more of the detected events, where the second intensity is greater than the first intensity.

6. The system according to claim 1 wherein one or more of the audio stream and the video stream is selected from:
a meta-data file;
a file pre-stored in the memory;
a multi-channel file;
a streaming file; and
a file generated in real time.

7. The system according to claim 1wherein the processor is further configured to execute a step of preprocessing of one or more of the audio stream and the video stream prior to the step of identification of events.

8. The system according to claim 7 wherein the preprocessing comprises one or more of reshaping of one or more of the audio stream and the video stream and replacing segments of one or both of the audio stream and the video stream in one or more frequency bands.

9. The system according to claim 1 wherein the analysis of one or more of the audio stream and the video stream comprises combining the audio stream with the video stream in a process involving a correlation between the audio stream and the video stream.

10. The system according to claim 1 wherein the processor is further configured to execute a step of relocating one or more predetermined components of one or more of the audio signal and the video signal in the stream.

11. The system according to claim 1 wherein identification of one or more events comprises any one or more of:
a. a spatial location of a source of one or ore of the audio steam and th video stream;
b. a spatial location of a user;
c. a movement or gesture of a user or a body part of a user.

12. The system according to claim 1 wherein the event identification involves one or more methods selected from:
a. waveform identification;
b. signal envelope analysis;
c. time domain correlation;
d. frequency domain segmentation and correlation;
e. surrounding events analysis;
f. embedded triggers;
g. object identification;
h. object contour identification;
i. image domain correlation;
j. image frequency domain segmentation and correlation; and
k. surrounding object analysis.

13. The according to claim 1 wherein the analysis of one or more of the audio stream and the video stream comprises combining the audio stream with the video stream in a process involving a correlation between the audio stream and the video stream.

14. The system according to claim 1 further comprising any one or more of:
(a) one or more display surfaces; and
(b) one or more speakers.

15. A method for generating haptic effects comprising:
analyzing one or more of an audio stream and a video stream to detect one or more predetermined events;
for each detected event generating a trigger at the onset of the event;
generating a first haptic signal of one or more predetermined haptic effects, where each haptic effect begins at a location of a trigger; and
sending the first haptic signal to one or more transducers.

16. The method according to claim 15 wherein the method further comprises:
generating a second haptic signal based upon an analysis of one or more of the input audio signal and the input video signal; and
sending the second haptic signal to one or more transducer simultaneously with the first haptic signal.

17. The method according to claim 16 wherein the second haptic signal is active between one or more of the detected events and is silent during one or more of the detected events.

18. The method according to claim 16 wherein the second haptic signal has a first intensity between one or more of the detected events and a second intensity during one or more of the detected events, where the second intensity is less than the first intensity.

19. The method according to claim 16 wherein the second haptic signal has a first intensity between one or more of the detected events and a second intensity during one or more of the detected events, where the second intensity is greater than the first intensity.
